(19) United States
(12) Patent Application Publication
(10) Pub. No.: US 2017/0078211 A1
(43) Pub. Date: Mar. 16, 2017

(54) TRANSMISSION METHOD, TRANSMISSION APPARATUS, AND STORAGE MEDIUM

(71) Applicant: FUJITSU LIMITED, Kawasaki-shi (JP)

(72) Inventors: Hideyo Fukunaga, Fukuoka (JP); MASAYOSHI MIHARA, Fukuoka (JP); Hideyuki KUDOU, Fukuoka (JP); Wataru Kanemori, Sawara (JP); Kazumasa Sonoda, Fukuoka (JP); Shinichi Fujiyoshi, Fukuoka (JP); YOSHINARI SUGIMOTO, Fukuoka (JP); Yoshikatsu KOHARA, Kitakyushu (JP)

(73) Assignee: FUJITSU LIMITED, Kawasaki-shi (JP)

(21) Appl. No.: 15/229,537

(22) Filed: Aug. 5, 2016

(30) Foreign Application Priority Data
Sep. 14, 2015 (JP) 2015-181237

(51) Int. Cl. H04L 12/823; H04L 12/26; H04L 12/875; H04L 12/851

(52) U.S. Cl. CPC H04L 47/323; H04L 47/2483; H04L 43/0894; H04L 47/56

(57) ABSTRACT

A transmission method executed by a transmission apparatus including a plurality of reception modules that receive packets and a plurality of transmission modules that receive the packets and transmit the packets to destinations of the packets, the transmission method includes extracting, by each of the plurality of reception modules, the amounts of data for respective priority levels of the received packets; transmitting, to one of the plurality of transmission modules, information regarding the extracted amounts of data for the respective priority levels; determining, by the one of the plurality of transmission modules, the amounts of discard data to be discarded for the plurality of respective reception modules, based on the extracted amounts of data for the respective priority levels and the amount of packet data that is able to be output; and notifying the plurality of reception modules of feedback information related to the determined amounts of discard data.

### CROSS-REFERENCE TO RELATED APPLICATION

This application is based upon and claims the benefit of priority of the prior Japanese Patent Application No. 2015-181237 filed on Sep. 14, 2015, the entire contents of which are incorporated herein by reference.

### FIELD

The embodiments discussed herein are related to a transmission method, a transmission apparatus, and a storage medium.

### BACKGROUND

A relay apparatus such as a router or a network switch outputs a packet input to an input port thereof, from the output port corresponding to the destination of the packet. A transmission apparatus of this kind has a bandwidth control function through which bandwidth control is performed on a network service basis or a user basis. A known relay apparatus performs bandwidth control using a single module (card) in the relay apparatus. For example, the amount of data received on the output-side controller side is monitored in the relay apparatus. An apparatus is disclosed that, in the case where the amount of data excesses the allowable amount of data, reports the amount of excess data to an input controller, and executes the bandwidth control function using an input-side module (see, for example, Japanese Laid-open Patent Publication No. 2009-124237).

As the mechanism of controlling a congestion state, there is a technique for reducing the degree of congestion by randomly discarding input data in accordance with a certain rule. There is a technique for uniformly applying back pressure to the input side in the case where there are a plurality of modules, and output congestion has occurred. There is a technique for performing discarding on a congestion queue at a certain probability. There is a technique having a plurality of input cards and a plurality of output cards and performing bandwidth allocation in accordance with a user-basis bandwidth use status (QoS: Quality of Service) (see, for example, Japanese Laid-open Patent Publication No. 2001-111556, Japanese Laid-open Patent Publication No. 2010-056885, Japanese Laid-open Patent Publication No. 2011-049658, and Japanese Laid-open Patent Publication No. 2010-187346).

When the same amount of packets of the same priority level is input to the modules, this does not arise a problem in known techniques. However, in the case where the amount of data differs from module to module, or packets with different priority levels are input to the modules in an unbalanced manner, communication quality may be degraded by packet transmission delay occurring at a specific module or unbalanced discarding. This is caused by the configuration with which a module does not grasp the congestion state of another module, and there arises, for example, a problem of discarding part of high-priority packets.

In a technique for controlling a congestion state, control is performed only within a single module. Even in the case of an apparatus including a plurality of modules, the congestion state of another module is not monitored or managed. Thus, in the known techniques, it is impossible to perform bandwidth control in accordance with packet priority levels or the congestion states of respective modules.

As above, there are no specific techniques for how to perform bandwidth limitation when the amount of input data is greater than the amount of output data that may be output, and furthermore for example how to perform, for one output port, bandwidth limitation on data input from a plurality of input ports. In addition, there is a demand for improvements regarding how to output input data having priority levels without discarding any of the input data. The above-described problems cause communication quality to decrease due to, for example, an interruption of communication of emergency information with a high priority level or continuous data such as video meetings and voice data. In light of the points above, it is desirable that bandwidth limitation based on priority levels be performed and communication quality be improved.

### SUMMARY

According to an aspect of the invention, a transmission method executed by a transmission apparatus including a plurality of reception modules that receive packets and transfer the packets to transfer destinations corresponding to destinations of the packets, and a plurality of transmission modules that receive packets from any of the plurality of reception modules and transmit the packets to destinations of the packets, the transmission method includes extracting, by each of the plurality of reception modules, the amounts of data for respective priority levels of the received packets; transmitting, to one of the plurality of transmission modules, information regarding the extracted amounts of data for the respective priority levels; determining, by the one of the plurality of transmission modules, the amounts of discard data to be discarded for the plurality of respective reception modules, based on the extracted amounts of data for the respective priority levels and the amount of packet data that is able to be output; and notifying the plurality of reception modules of feedback information related to the determined amounts of discard data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a transmission apparatus according to an embodiment;

FIG. 2 is a diagram illustrating details of the configuration of the input controller side of the transmission apparatus according to the embodiment;

FIG. 3 is a flowchart illustrating the processing procedure about queue information transmission performed by the transmission apparatus according to the embodiment;

FIG. 4 is a flowchart illustrating the processing procedure about feedback information reception performed by the transmission apparatus according to the embodiment;

FIG. 5 is a diagram illustrating details of a queue information monitoring-comparison unit of a transmission apparatus according to an embodiment;

FIG. 6 is a diagram illustrating an example of a hardware configuration of the transmission apparatus according to the embodiment;

FIG. 7 is a flowchart illustrating an example of bandwidth allocation arithmetic processing performed by the transmission apparatus according to the embodiment;

FIG. 8 is a flowchart illustrating an example of reception bandwidth calculation processing performed by the transmission apparatus according to the embodiment;

FIG. 9 is a diagram illustrating an example of bandwidth allocation performed by the transmission apparatus according to the embodiment;

FIG. 10 is a diagram illustrating another example of bandwidth allocation performed by the transmission apparatus according to the embodiment;

FIG. 11 is a diagram illustrating an example of the configuration of a network that is an application example of the transmission apparatus according to the embodiment; and

FIG. 12 is a diagram illustrating bandwidth allocation in an existing transmission apparatus.

### DESCRIPTION OF EMBODIMENTS

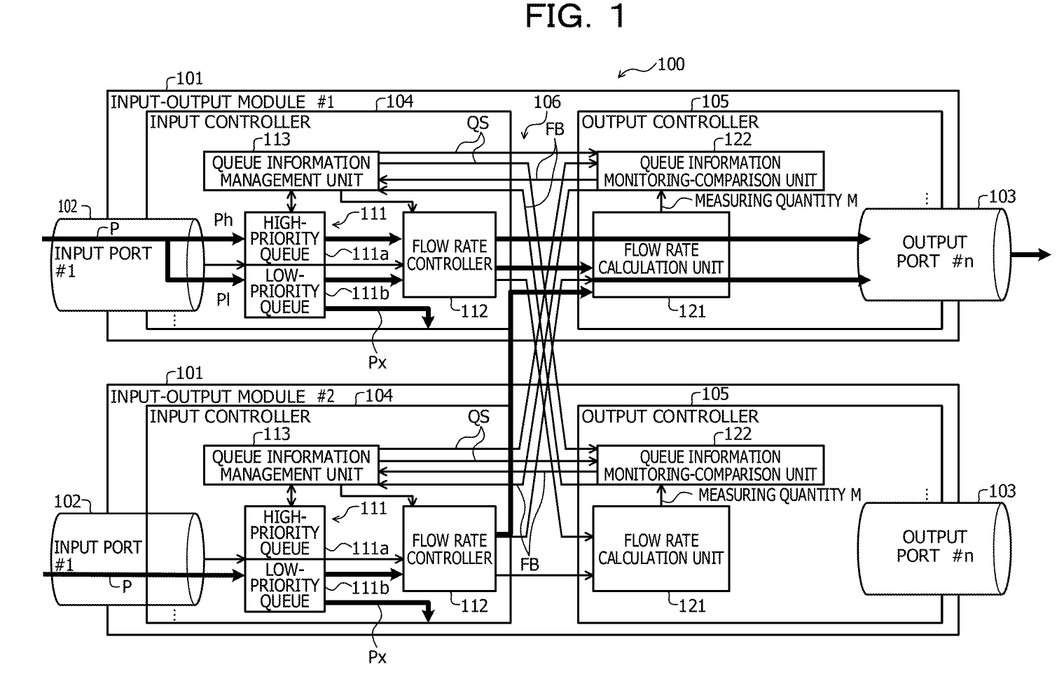

FIG. 1 is a block diagram illustrating a transmission apparatus according to an embodiment. A transmission apparatus 100 includes, for example, two input-output modules #1 and #2 (101). Each input-output module 101 includes a plurality (1 to n) of input ports 102 and a plurality (1 to n) of output ports 103. FIG. 1 illustrates, for convenience sake, one input port 102 denoted by #1 and one output port 103 denoted by #n.

The transmission apparatus 100 outputs packets P from any of the plurality of output ports 103, which is the destination of the packets P, of the plurality of input-output modules 101 in the transmission apparatus 100, the packets P being input from the plurality of input ports 102 of the plurality of input-output modules 101. Although not illustrated in FIG. 1, each input-output module 101 includes a plurality of reception modules (corresponding to input controllers 104 of FIG. 1) on the side to which packets are input from the outside. The packets sorted by the reception modules are output to the outside from a plurality of transmission modules (corresponding to output-side controllers 105 of FIG. 1) in the subsequent stage.

In the example of FIG. 1, a packet P input from an input port #1 (102) of the input-output module #1 (101) is output from an output port #n (103) of the same input-output module #1 (101). A packet P input from an input port #1 (102) of the input-output module #2 (101) is output from the output port #n (103) of the other input-output module #1 (101). Some packets P (discard packets Px) may be discarded under bandwidth allocation control, which is to be described later.

Each input controller 104 includes an input port 102, a queue 111, a flow rate controller 112, and a queue information management unit 113. The queue 111, the flow rate controller 112, and the queue information management unit 113 function as an input-side controller that performs packet control on the packet input side (the reception-module side). Each output-side controller 105 includes a flow rate calculation unit 121, a queue information monitoring-comparison unit 122, and an output port 103. The flow rate calculation unit 121 and the queue information monitoring-comparison unit 122 function as an output-side controller that performs packet control on the packet output side (the transmission-module side).

A back wired board (BWB) 106 is provided between each input controller 104 and each output-side controller 105, transmission paths are connected in a mesh (crossing) like manner, and packets P are transferred. That is, a packet P input from the input controller 104 is transferred to any of the plurality of output-side controllers 105 corresponding to the destination (an output port 103) by the BWB 106 in the transmission apparatus 100, and is output from the output-side controller 105.

The configuration of the side where the input controller 104 is provided will be described. The input port 102 sorts packets P into certain queues of the queue 111 in accordance with priority levels assigned to the input packets P, which are synonymous with data. The input port 102 sorts, among the input packets P, packets with a high priority level (high-priority data) Ph into a high-priority queue 111a. The input port 102 sorts, among the input packets P, packets with a low priority level (low-priority data) Pl into a low-priority queue 111b. The packets P (Ph, Pl) sorted into the certain queues of the queue 111 are output to the flow rate controller 112, and for each of the priority levels, the flow rate is limited under bandwidth control performed by the queue information management unit 113.

In FIG. 1, bold lines indicating the packets P (Ph, Pl) illustrate an example of data flow in the transmission apparatus 100. An example of flow-rate limitation control performed on these packets P will be described later.

The configuration of the side where the output-side controller 105 is provided will be described. The flow rate calculation unit 121 calculates the flow rates of the packets P (Ph, Pl) to be output from the output port 103, and outputs a measuring quantity M to the queue information monitoring-comparison unit 122.

The queue information management unit 113 provided on the side where the input controller 104 is provided extracts the data lengths (queue lengths) of the packets stored in the queue 111 (111a, 111b). The queue information management unit 113 outputs, as queue information QS, the priority level of each packet and the queue lengths to the queue information monitoring-comparison units 122 of the output-side controllers 105 of the plurality of input-output modules 101 in the transmission apparatus 100.

The queue information monitoring-comparison unit 122 provided on the side where the output-side controller 105 is provided acquires pieces of queue information QS output from the input controllers 104 of the plurality of input-output modules 101 in the transmission apparatus 100 and the flow rates of the packets P (Ph, Pl) calculated by the flow rate calculation unit 121. The queue information monitoring-comparison unit 122 calculates the reception bandwidth of each input module, based on these acquired pieces of queue information QS and information regarding the flow rates.

The queue information monitoring-comparison unit 122 asks packet sorting (output) in the order of the priority levels, based on the congestion state of the output port 103. Here, packets to be discarded are packets having a low priority level. Thereafter, feedback information FB including the priority level of each packet to be output from the output port 103 and an output permission bandwidth is output to the queue information management units 113 of the input controllers 104 of the plurality of input-output modules 101 in the transmission apparatus 100.

The queue information QS is output to the output-side controllers 105 of the input-output modules #1 and #2 (101), and the feedback information FB is output to the input controllers 104 of the input-output modules #1 and #2 (101). As illustrated in FIG. 1, the queue information QS and the feedback information FB are also input and output in a mesh (crossing) like manner.

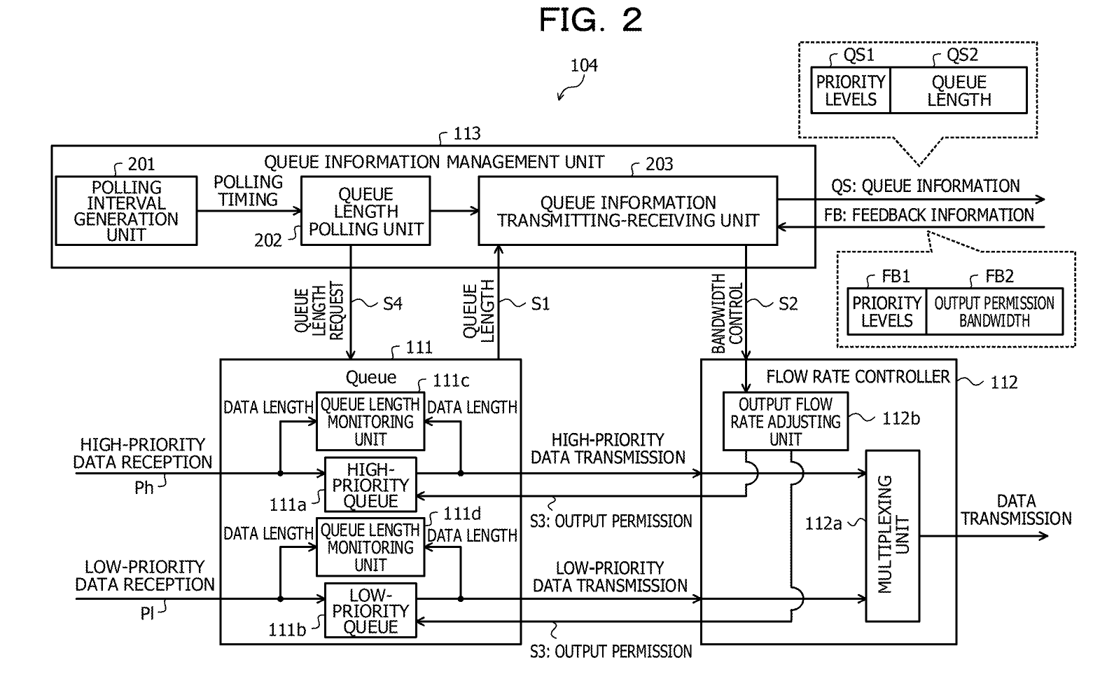

FIG. 2 is a diagram illustrating details of the configuration of the input controller side of the transmission apparatus according to the embodiment. The details of a configuration including the queue information management unit 113 provided on the side where the input controller 104 illustrated in FIG. 1 is provided will be described.

The queue 111 includes a high-priority queue 111a for storing packets with a high priority level (high priority level), and a low-priority queue 111b for storing packets with a low priority level (low priority level). The output flow rate for the high-priority queue 111a and that for the low-priority queue 111b are individually controlled based on output permission information S3 output from the flow rate controller 112.

For the packets stored in the high-priority queue 111a and those in the low-priority queue 111b, the queue lengths of the packets (the amounts of data on a packet basis) are monitored by queue length monitoring units 111c and 111d. Information S1 regarding the queue lengths for respective priority levels monitored by the queue length monitoring units 111c and 111d is output to the queue information management unit 113.

The flow rate controller 112 includes a multiplexing unit 112a and an output flow rate adjusting unit 112b. The multiplexing unit 112a multiplexes high-priority and low-priority packets Ph and Pl output from the queue 111, and performs data transmission to the output-side controller 105. The output flow rate adjusting unit 112b outputs, based on bandwidth control information S2 output by the queue information management unit 113, the output permission information S3 used to adjust the output flow rate of the high-priority packets Ph and that of the low-priority packets Pl to the high-priority queue 111a and the low-priority queue 111b.

The queue information management unit 113 includes a polling interval generation unit 201, a queue length polling unit 202, and a queue information transmitting-receiving unit 203.

A packet P input to the queue 111 is sorted in accordance with the priority level assigned to this packet P. A high-priority packet Ph is stored in the high-priority queue 111a, and a low-priority packet Pl is stored in the low-priority queue 111b. The priority level and packet length of the packet P change with time.

The polling interval generation unit 201 includes, for example, a counter. The polling interval generation unit 201 measures a certain period of time (for example, 1 millisecond or 1 second), and notifies the queue length polling unit 202 of time at regular intervals. The queue length polling unit 202 makes an inquiry (queue length request) regarding the degree of queue length to the queue length monitoring units 111c and 111d by transmitting queue length request information S4 at the polling timings received from the polling interval generation unit 201.

When receiving, from the queue 111, information S1 regarding the queue lengths for the respective priority levels, the queue information transmitting-receiving unit 203 generates queue information QS, and transmits the queue information QS to the queue information monitoring-comparison unit 122 of the output-side controller 105. The queue information QS includes priority levels QS1 and priority-level-basis queue length information QS2.

The queue information transmitting-receiving unit 203 outputs, to the flow rate controller 112, bandwidth control information S2 based on the feedback information FB received from the queue information monitoring-comparison unit 122. The queue information transmitting-receiving unit 203 outputs, to the output flow rate adjusting unit 112b of the flow rate controller 112, priority-level-basis bandwidth control information S2 based on priority levels FB1 and priority-level-basis output permission bandwidth information FB2 included in the feedback information FB.

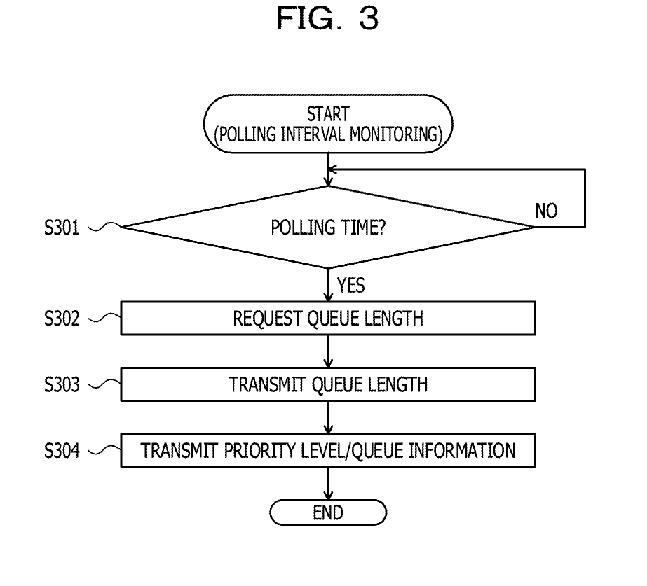

FIG. 3 is a flowchart illustrating the processing procedure about queue information transmission performed by the transmission apparatus according to the embodiment. FIG. 3 illustrates the content of processing up until when the queue information management unit 113 transmits the queue information QS.

First, the queue information management unit 113 starts polling interval monitoring using the polling interval generation unit 201. Then, the queue information management unit 113 determines, at a certain polling timing, whether a polling time has reached, using the queue length polling unit 202 (S301). The queue information management unit 113 is on standby until the polling time reaches (No loop in S301). When the polling time reaches (Yes in S301), the queue length polling unit 202 outputs queue length request information S4 to the queue 111 (S302).

The queue length monitoring units 111c and 111d of the queue 111 receive the queue length request information S4. As a result, the queue length monitoring unit 111c transmits, to the queue information management unit 113 (the queue information transmitting-receiving unit 203), information S1 (priority levels and priority-level-basis queue lengths) regarding the data lengths (queue lengths) of the packets P stored in the respective queues 111a and 111b. The queue length monitoring unit 111c transmits the queue length of high-priority packets Ph. The queue length monitoring unit 111d transmits the queue length of low-priority packets Pl (S303).

The queue information transmitting-receiving unit 203 of the queue information management unit 113 transmits, to the output-side controller 105 (the queue information monitoring-comparison unit 122), queue information QS including the received priority levels and the priority-level-basis queue lengths (S304).

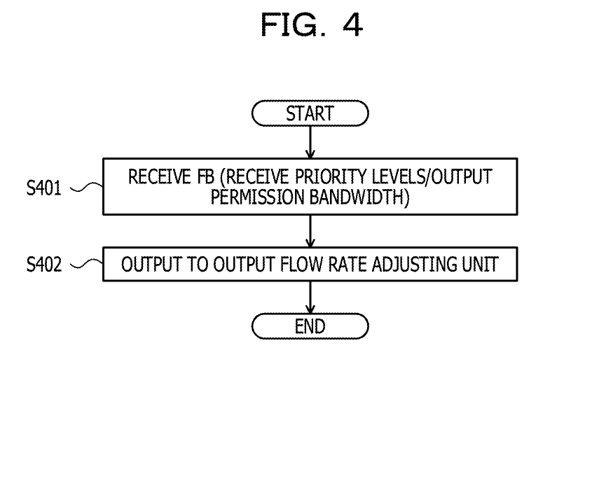

FIG. 4 is a flowchart illustrating the processing procedure about feedback information reception performed by the transmission apparatus according to the embodiment. FIG. 4 illustrates the content of processing of feedback information FB received by the queue information transmitting-receiving unit 203.

The queue information transmitting-receiving unit 203 of the queue information management unit 113 receives feedback information FB from the output-side controller 105 (S401). This feedback information FB includes priority levels FB1 and priority-level-basis output permission bandwidth information FB2. The queue information transmitting-receiving unit 203 outputs, to the output flow rate adjusting unit 112b of the flow rate controller 112, priority-level-basis bandwidth control information S2 (S402).

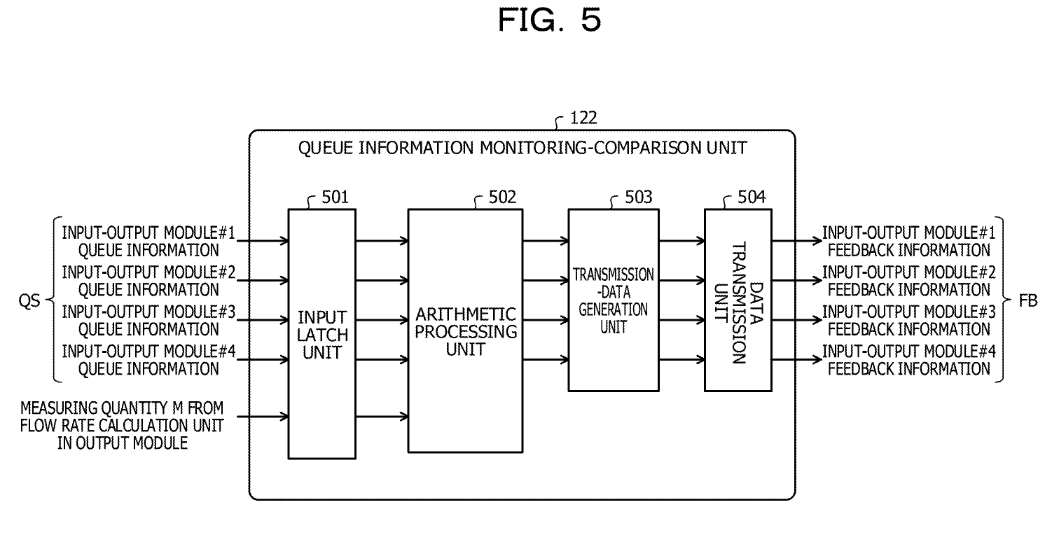

FIG. 5 is a diagram illustrating details of the queue information monitoring-comparison unit of a transmission apparatus according to an embodiment. The queue information monitoring-comparison unit 122 includes an input latch unit 501, an arithmetic processing unit 502, a transmission-data generation unit 503, and a data transmission unit 504. In FIG. 1, the number of the input-output modules 101 provided in the transmission apparatus 100 is two (#1 and #2). However, FIG. 5 illustrates an example in which the number of input-output modules 101 is four.

The input latch unit 501 captures and maintains (latches) queue information QS output from input controllers 104 (queue information management units 113) of a plurality of input-output modules #1 to #4 (101) provided in the transmission apparatus 100. The input latch unit 501 latches a measuring quantity M output from the flow rate calculation unit 121.

The arithmetic processing unit 502 calculates, for each input-output module 101 (input controller 104), reception bandwidths and the amounts of packets (the amount of data) to be discarded, based on the bandwidth of the output port 103 (the amount of data that may be output), the queue information QS, and the measuring quantity M. An example of calculation performed by the arithmetic processing unit 502 will be described later.

The transmission-data generation unit 503 generates feedback information FB including priority levels FB1 and priority-level-basis output permission bandwidth information FB2, based on the calculation performed by the arithmetic processing unit 502. The data transmission unit 504 transmits the feedback information FB to the input controllers 104 of the plurality of input-output modules #1 to #4 (101) provided in the transmission apparatus 100. The feedback information FB is transmitted to the flow rate controllers 112 via the queue information management units 113 of the input controllers 104 of the plurality of input-output modules #1 to #4 (101).

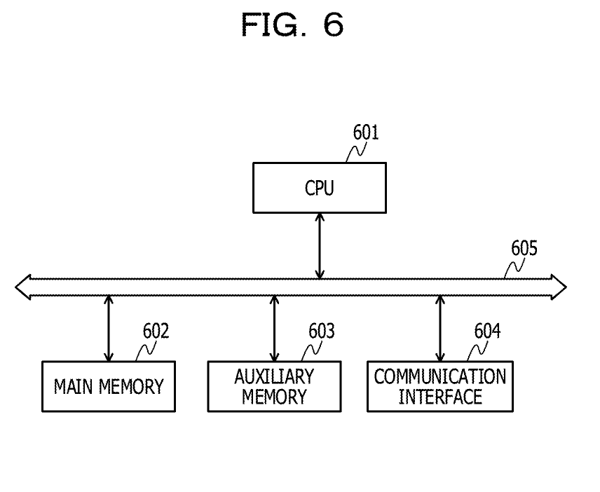

FIG. 6 is a diagram illustrating an example of a hardware configuration of the transmission apparatus according to the embodiment. The input-output modules #1 to #2 (101) illustrated in FIG. 1 may each be configured by a circuit element and the like mounted on a card. In addition to this, the functions of the queue information management units 113 and queue information monitoring-comparison units 122 of the input-output modules #1 to #2 (101) may be configured by software.

FIG. 6 illustrates an example of a hardware configuration in the case where the queue information management units 113 and queue information monitoring-comparison units 122 of the input-output modules #1 to #2 (101) are configured by software. The queue information management units 113 and the queue information monitoring-comparison units 122 include a central processing unit (CPU) 601, a main memory 602, an auxiliary memory 603, and a communication interface (I/F) 604. The CPU 601, the main memory 602, the auxiliary memory 603, and the communication I/F 604 are connected via a bus 605.

The CPU 601 controls the queue information management units 113 and the queue information monitoring-comparison units 122. The main memory 602 is, for example, a random access memory (RAM). The main memory 602 is used as a work area of the CPU 601. The auxiliary memory 603 is, for example, a nonvolatile memory such as a flash memory. A program for operating the queue information management units 113 and the queue information monitoring-comparison units 122 is stored in the auxiliary memory 603. The program stored in the auxiliary memory 603 is loaded into the main memory 602, and executed by the CPU 601.

The communication I/F 604 is a communication interface for performing communication between each queue information management unit 113 and the outside and between each queue information monitoring-comparison unit 122 and the outside. For example, the communication I/Fs 604 transmits and receives the queue information QS or feedback information FB between the plurality of input-output modules #1 to #2 (101).

The example of FIG. 6 is configured such that the functions of the queue information management units 113 and queue information monitoring-comparison units 122 are executed by the CPU 601, which is a single CPU. However, the queue information management units 113 and the queue information monitoring-comparison units 122 may have respective CPUs 601 (the configuration illustrated in FIG. 6).

In the case where the functions of the queue information management units 113 and queue information monitoring-comparison units 122 are configured by software, the configurations of input-output modules #1 to #2 (1201) of an existing transmission apparatus may be used as they are. In this case, the configuration corresponding to the embodiment may be easily realized by adding the functions of the queue information management units 113 and queue information monitoring-comparison units 122.

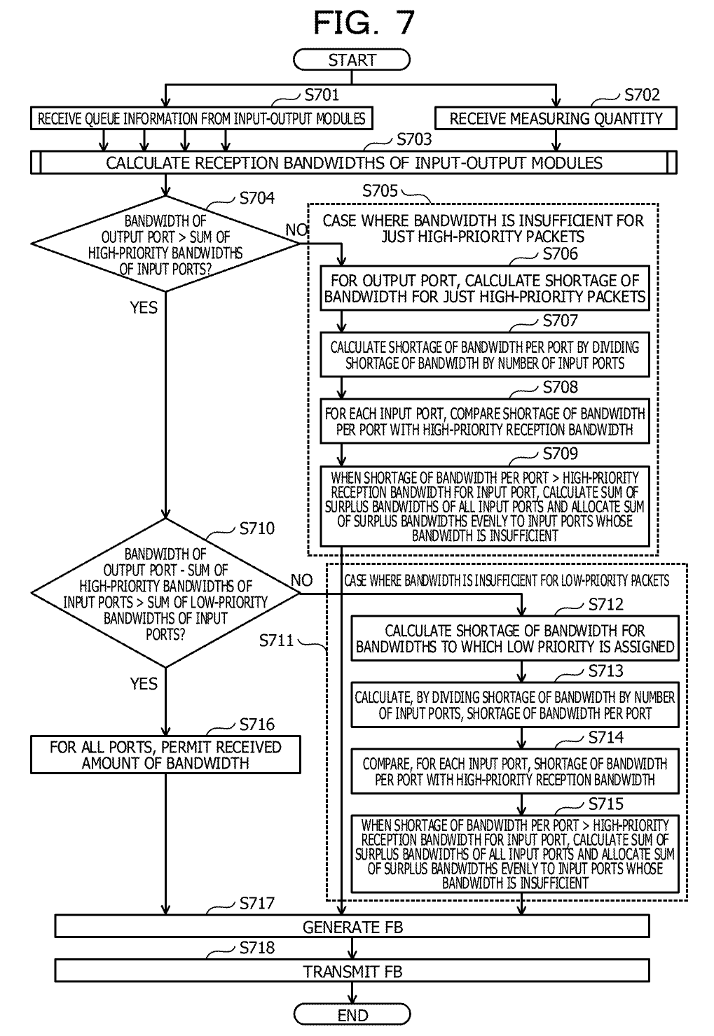

FIG. 7 is a flowchart illustrating an example of bandwidth allocation arithmetic processing performed by the transmission apparatus according to the embodiment. An example of main processing executed by the arithmetic processing unit 502 of each queue information monitoring-comparison unit 122 will be described. The processing of FIG. 7 illustrates an example in which a plurality of input-output modules #1 to #n (101) included in the transmission apparatus 100 discard packets P evenly. The arithmetic processing unit 502 executes the processing of FIG. 7 at certain unit processing times (for example, every 1 second) corresponding to a change in the amount of packets per elapsed time.

Here, each of the arithmetic processing units 502 of the input-output modules 101 having the output ports 103 outputting packets P executes the processing illustrated in FIG. 7. For example, in the example of FIG. 1, the output destination of packets P input from the input port #1 (102) of the input-output module #1 (101) and the input port #1 (102) of the input-output module #2 (101) is the output port #n (103) of the input-output module #1 (101).

In this case, the arithmetic processing unit 502 of the input-output module #1 (101) having the output port #n (103) of the input-output module #1 (101) executes the following arithmetic processing. In the following, (the number of) input ports and (the number of) output ports indicate (the number of) ports to and from which packets P are input and output.

First, the arithmetic processing unit 502 receives pieces of queue information QS from the respective input-output modules 101 (S701), and receives a measuring quantity M from the flow rate calculation unit 121 (S702). Then, the arithmetic processing unit 502 calculates, from these pieces of queue information QS and the measuring quantity M, the reception bandwidths of the respective input-output modules 101 (S703). The bandwidth of the output port 103 (the amount of data that may be output) is preset. Here, the reception bandwidth for high-priority data (the high-priority queue 111a) and that for low-priority data (the low-priority queue 111b) are calculated.

Next, based on the reception bandwidths calculated for the respective certain queues of the queue 111 (the high-priority queue 111a and the low-priority queue 111b), the arithmetic processing unit 502 chooses one of the following three processes so as to correspond to the congestion state of the output port 103.

1. The case where the bandwidth of the output port 103 is insufficient for just high-priority packets Ph (S705). 2. The case where the bandwidth of the output port 103 is insufficient for low-priority packets Pl and the high-priority packets Ph (S711). 3. The case where the bandwidth of the output port 103 is sufficient (no congestion) for the sum of all the bandwidths (all the packets P) (S716).

In S704, the arithmetic processing unit 502 determines whether the bandwidth of the output port 103, which is the output destination of each packet P, exceeds the sum of the high-priority bandwidths of the input ports 102 (the bandwidths for high-priority packets Ph at the input ports 102) (S704). In the case where it is determined that the bandwidth of the output port 103 exceeds the sum of the high-priority bandwidths of the input ports 102 (Yes in S704), the arithmetic processing unit 502 causes the process to proceed to S710. In contrast, in the case where it is determined that the bandwidth of the output port 103 does not exceed the sum of the high-priority bandwidths of the input ports 102 (No in S704), the processing of S705 is executed.

In S705, the processing for the above-described case 1 where the bandwidth of the output port 103 is insufficient for just high-priority packets Ph is performed. First, the arithmetic processing unit 502 calculates, for the output port 103, a shortage of bandwidth for just the high-priority packets Ph (S706). Next, the arithmetic processing unit 502 calculates, by dividing the shortage of bandwidth by the number of the input ports 102 for the high-priority packets Ph, a shortage of bandwidth per port (S707).

Next, the arithmetic processing unit 502 compares, for each input port 102, the shortage of bandwidth per port calculated in S707 with a high-priority reception bandwidth (S708). When the shortage of bandwidth per port exceeds the high-priority reception bandwidth of the input port 102, the arithmetic processing unit 502 calculates the sum of surplus bandwidths of all the input ports 102. The sum of the surplus bandwidths is evenly allocated to the input ports 102 whose bandwidth is insufficient (S709). Thereafter the process proceeds to the processing of S717.

In S710, the arithmetic processing unit 502 determines whether the bandwidth acquired by subtracting the sum of the high-priority bandwidths of the input ports from the bandwidth of the output port 103 exceeds the sum of the low-priority bandwidths of the input ports 102 (the bandwidths for low-priority packets Pl at the input ports 102) (S710). As a result of the determination, when the bandwidth acquired by subtracting the sum of the high-priority bandwidths of the input ports from the bandwidth of the output port 103 exceeds the sum of the low-priority bandwidths of the input ports (Yes in S710), the arithmetic processing unit 502 causes the process to proceed to S716. When the bandwidth acquired by subtracting the sum of the high-priority bandwidths of the input ports from the bandwidth of the output port 103 does not exceed the sum of the low-priority bandwidths of the input ports (No in S710), the processing of S711 is executed.

In S711, the processing for the above-described case 2 where the bandwidth of the output port 103 is insufficient for low-priority packets Pl and the high-priority packets Ph is performed. First, the arithmetic processing unit 502 calculates a shortage of bandwidth for the bandwidths to which low priority is assigned (S712). Next, the arithmetic processing unit 502 calculates, by dividing the calculated shortage of bandwidth by the number of the input ports 102, a shortage of bandwidth per port (S713).

Thereafter, the arithmetic processing unit 502 compares, for each input port 102, the shortage of bandwidth per port with the high-priority reception bandwidth (S714). Next, when the shortage of bandwidth per port exceeds the high-priority reception bandwidth of the input port 102, the arithmetic processing unit 502 calculates the sum of surplus bandwidths of all the input ports 102. The sum of the surplus bandwidths is evenly allocated to the input ports 102 whose bandwidth is insufficient (S715). Thereafter the process proceeds to the processing of S717.

In S717, the transmission-data generation unit 503 generates feedback information FB, based on the calculation result of the arithmetic processing unit 502 (S717). The feedback information FB is transmitted by the data transmission unit 504 to the input-output modules 101 in which all the input ports 102 are provided to which packets P are currently being input (S718). The feedback information FB includes priority levels FB1 and priority-level-basis output permission bandwidth information FB2, and is output to the queue information management unit 113 to the flow rate controller 112 of each input-output module 101, and the rate of flow output by the input controller 104 is controlled.

The above-described example of processing illustrates an example of the case where packets P are evenly discarded at the input ports 102 transporting the packets P. However, for each input port 102, the rate of discarding of packets P may be changed by changing arithmetic parameters or the like.

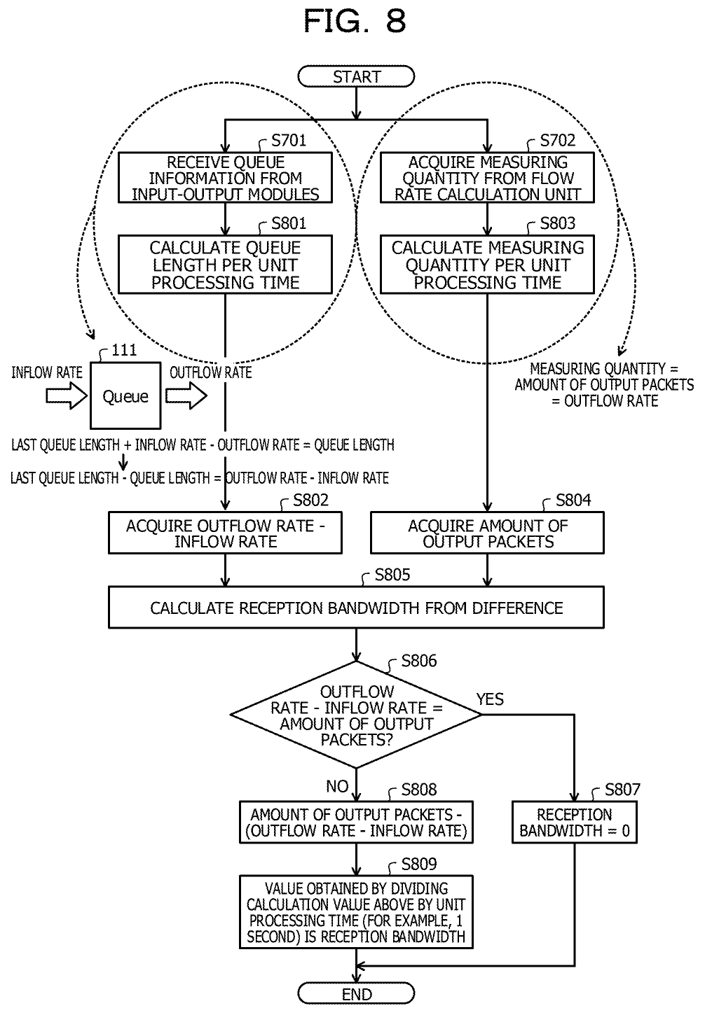

FIG. 8 is a flowchart illustrating an example of reception bandwidth calculation processing performed by the transmission apparatus according to the embodiment. The details of calculation processing of the reception bandwidth of each input-output module 101 illustrated in S703 of FIG. 7 and executed by the arithmetic processing unit 502 will be described.

The arithmetic processing unit 502 calculates, from the queue information QS received from each input-output module 101 (S701), a queue length per unit processing time (for example, 1 second) (S801). For example, the queue length monitoring units 111c and 111d illustrated in FIG. 2 monitor the inflow rate and outflow rate of packets P for the queues 111a and 111b. Thus, each of the queue length monitoring units 111c and 111d calculates the queue length by performing the last queue length+the inflow rate−the outflow rate. The arithmetic processing unit 502 acquires the outflow rate−the inflow rate by performing the last queue length−the (current) queue length (S802).

The arithmetic processing unit 502 calculates a measuring quantity M per unit processing time (1 second) from the measuring quantity M (S702) received from the flow rate calculation unit 121 (S803). The measuring quantity M is the amount of packets P output from the output port 103, and corresponds to the outflow rate of S802. In S804, this amount of output packets P is acquired (S804).

Next, the arithmetic processing unit 502 calculates a reception bandwidth, based on the presence or absence of the difference between the outflow rate−the inflow rate acquired in S802 and the amount of output packets P acquired in S804 and the difference (S805). Specifically, the arithmetic processing unit 502 determines whether the outflow rate−the inflow rate=the amount of output packets P (S806).

In the case where the outflow rate−the inflow rate is the amount of output packets P (Yes in S806), the arithmetic processing unit 502 determines that the reception bandwidth is zero (S807). In contrast, in the case where the outflow rate−the inflow rate is not the amount of output packets P (No in S806), the arithmetic processing unit 502 subtracts (the outflow rate−the inflow rate) from the amount of output packets P and acquires the resulting calculation value (S808). The arithmetic processing unit 502 determines that the value obtained by dividing the calculation value by the unit processing time (for example, 1 second) is the reception bandwidth (S809). After the processing of S807 and S809, the arithmetic processing unit 502 causes the process to proceed to the processing of S704 of FIG. 7.

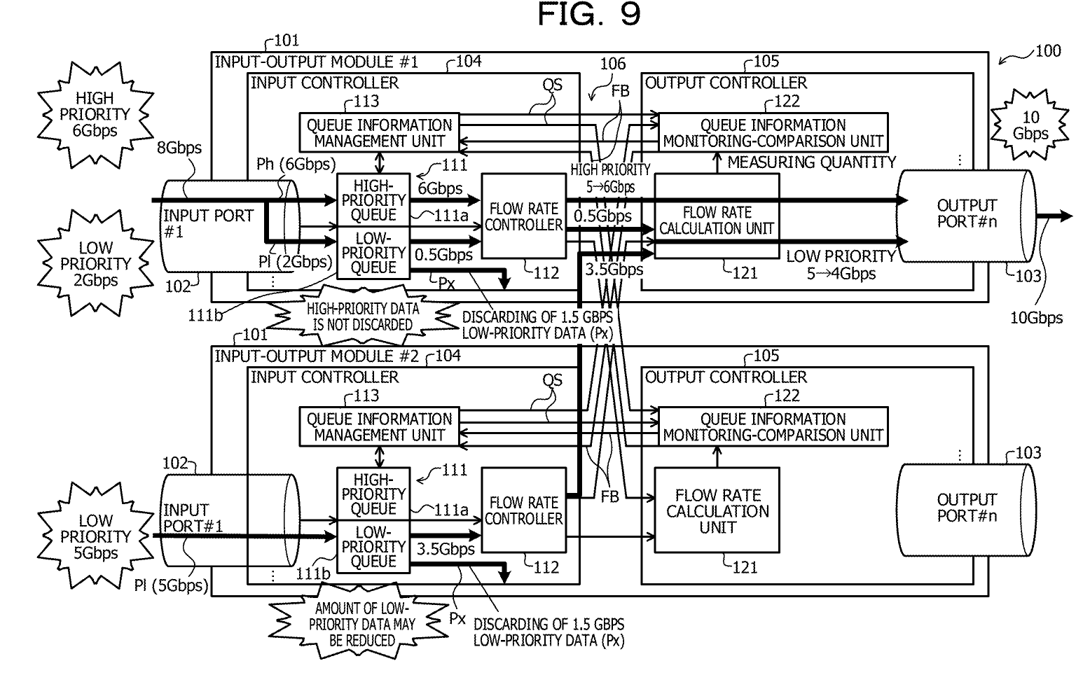

FIG. 9 is a diagram illustrating an example of bandwidth allocation performed by the transmission apparatus according to the embodiment. FIG. 9 illustrates an exemplary configuration similar to that of FIG. 1, and an example in which the outflow rates of packets P are adjusted for the input-output modules 101 such that the amounts of packets to be discarded will become equal for the input-output modules 101 will be described using FIG. 9.

The data (packets P) input individually from the input port #1 (102) of the input-output module #1 (101) and the input port #1 (102) of the input-output module #2 (101) flows into the output port #n (103) of the input-output module #1 (101). The bandwidth of the output port #n (103) is limited to 10 Gbps.

To the input port #1 (102) of the input-output module #1 (101), 8-Gbps data (6-Gbps high-priority data and 2-Gbps low-priority data) is input. To the input port #1 (102) of the input-output module #2 (101), 5-Gbps data (5-Gbps low-priority data) is input.

The queue information management unit 113 of the input-output module #1 (101) transmits, as queue information QS, 6 Gbps that is a high-priority-data inflow rate and 2 Gbps that is a low-priority-data inflow rate, to the queue information monitoring-comparison units 122 of the input-output modules #1 and #2 (101). The queue information management unit 113 of the input-output module #2 (101) transmits, as queue information QS, 0 Gbps that is a high-priority-data inflow rate and 5 Gbps that is a low-priority-data inflow rate, to the queue information monitoring-comparison units 122 of the input-output modules #1 and #2 (101).

Here, the output port #n that outputs the packets P belongs to the input-output module #1 (101). Thus, the queue information monitoring-comparison unit 122 (the arithmetic processing unit 502) of this input-output module #1 (101) performs the following calculation, based on the queue information QS received from the input-output modules #1 and #2 (101).

(1) The sum of inflow rates on a priority-level basis

High-priority data: 6 Gbps+0 Gbps=6 Gbps

Low-priority data: 2 Gbps+5 Gbps=7 Gbps

(2) Calculation of the remaining bandwidth in the case where high-priority data output is prioritized

Remaining Bandwidth: 10 Gbps−6 Gbps=4 Gbps

(3) The sum of the numbers of active input ports where data exists on a priority-level basis

High-priority Data: One port

Low-priority Data: Two ports

(4) (The sum of inflow rates for the low-priority data−the remaining bandwidth)/the number of active low-priority input ports

(7 Gbps−4 Gbps)/2=1.5 Gbps

(5) The low-priority data output permission bandwidth for each port

The input-output module #1: 2 Gbps−1.5 Gbps=0.5 Gbps

The input-output module #2: 5 Gbps−1.5 Gbps=3.5 Gbps

Based on the above-described calculations, the queue information monitoring-comparison unit 122 transmits, as feedback information FB, an output permission of the following amounts of data to the queue information management units 113 of the two input-output modules #1 and #2 (101) having the input port #1 (102) for the packets P.

To the queue information management unit 113 of the input-output module #1, 6 Gbps+0.5 Gbps=6.5 Gbps

To the queue information management unit 113 of the input-output module #2, 0 Gbps+3.5 Gbps=3.5 Gbps

As a result, as illustrated in FIG. 9, the input-output modules #1 and #2 (101) output only the permitted amounts of data indicated by the priority-level-basis output permission bandwidth information FB2 included in the feedback information FB.

In the input-output module #1 (101), the entire input high-priority data (Ph) may be transferred, and 1.5 Gbps data of the 2-Gbps low-priority data is discarded as discard packets Px under the above-described bandwidth allocation control. In the input-output module #2 (101), 3.5 Gbps data of the input 5-Gbps low-priority data is transferred, and 1.5 Gbps data is discarded as discard packets Px. In this manner, the amount of packets P to be discarded will be the same for the input-output modules #1 and #2 (101).

In the above-described example, packets are also discarded on the input-output module #2 (101) side, and packet discarding that has hitherto occurred only at the input-output module #1 (101) may be solved. Furthermore, discarding of packets Ph, which are high-priority data, may be avoided.

In this manner, even with the configuration in which a plurality of input-output modules are provided in a transmission apparatus, packets are intersected between the input-output modules, and packets are output from another input-output module, bandwidth allocation for packets may be appropriately performed, for the plurality of input-output modules, in accordance with transmission paths and priority levels.

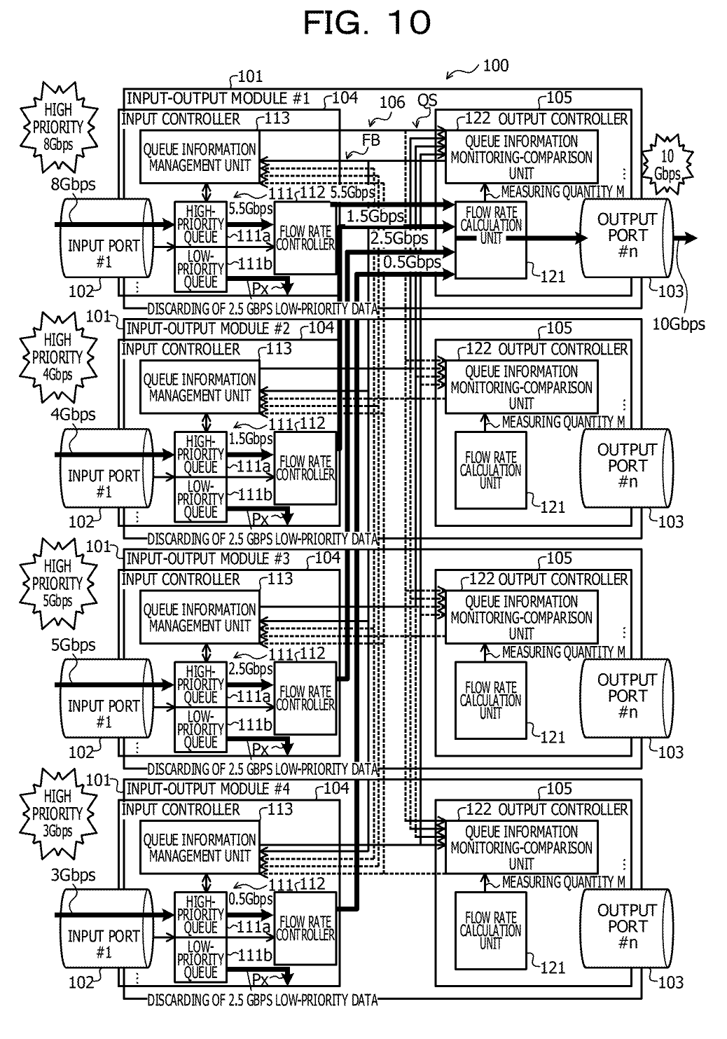

FIG. 10 is a diagram illustrating another example of bandwidth allocation performed by the transmission apparatus according to the embodiment. Four (#1 to #4) input-output modules 101 which are the same as those illustrated in FIG. 1, are provided in the transmission apparatus 100 of FIG. 10. An example in which the outflow rates of packets P are adjusted for the input-output modules 101 such that the amounts of packets to be discarded will become equal for the input-output modules #1 to #4 (101) will be described using FIG. 10. The example of FIG. 10 illustrates a state in which the bandwidth of an output port 103 is insufficient for just a specific priority level (the entire high-priority data).

The data (packets P) input individually from the input ports #1 (102) of the input-output modules #1 to #4 (101) flows into the output port #n (103) of the input-output module #1 (101). The bandwidth of the output port #n (103) is limited to 10 Gbps.

To the input port #1 (102) of the input-output module #1 (101), 8-Gbps data (8-Gbps high-priority data) is input. To the input port #1 (102) of the input-output module #2 (101), 4-Gbps data (4-Gbps high-priority data) is input. To the input port #1 (102) of the input-output module #3 (101), 5-Gbps data (5-Gbps high-priority data) is input. To the input port #1 (102) of the input-output module #4 (101), 3-Gbps data (3-Gbps high-priority data) is input. The sum of the inflow rates of data to the input ports #1 is 20 Gbps.

The queue information management unit 113 of the input-output module #1 (101) transmits, as queue information QS, 8 Gbps that is a high-priority-data inflow rate to the queue information monitoring-comparison unit 122.

The queue information management unit 113 of the input-output module #2 (101) transmits, as queue information QS, 4 Gbps that is a high-priority-data inflow rate to the queue information monitoring-comparison unit 122.

The queue information management unit 113 of the input-output module #3 (101) transmits, as queue information QS, 5 Gbps that is a high-priority-data inflow rate to the queue information monitoring-comparison unit 122.

The queue information management unit 113 of the input-output module #4 (101) transmits, as queue information QS, 3 Gbps that is a high-priority-data inflow rate to the queue information monitoring-comparison unit 122.

Here, the output port #n that outputs the packets P belongs to the input-output module #1 (101). Thus, the queue information monitoring-comparison unit 122 (the arithmetic processing unit 502) of this input-output module #1 (101) performs the following calculation, based on the queue information QS received from the input-output modules #1 and #4 (101).

(1) The sum of inflow rates on a priority-level basis

8 Gbps+4 Gbps+5 Gbps+3 Gbps=20 Gbps

(2) Calculation of the remaining bandwidth in the case where high-priority data output is prioritized

10 Gbps−20 Gbps=−10 Gbps

(3) The sum of the numbers of active input ports where data exists on a priority-level basis

High-priority data: Four Ports

(4) The remaining bandwidth/the number of active input ports

10 Gbps/4=2.5 Gbps

(5) The priority output permission bandwidth for each port

Input-output module #1: 8 Gbps−2.5 Gbps=5.5 Gbps

Input-output module #2: 4 Gbps−2.5 Gbps=1.5 Gbps

Input-output module #3: 5 Gbps−2.5 Gbps=2.5 Gbps

Input-output module #4: 3 Gbps−2.5 Gbps=0.5 Gbps

Based on the above-described calculations, the queue information monitoring-comparison unit 122 transmits, as feedback information FB, an output permission of the following amounts of data to the queue information management units 113 of the four input-output modules #1 to #4 (101) having the input port #1 (102) for the packets P.

To the queue information management unit 113 of the input-output module #1, 5.5 Gbps

To the queue information management unit 113 of the input-output module #2, 1.5 Gbps

To the queue information management unit 113 of the input-output module #3, 2.5 Gbps

To the queue information management unit 113 of the input-output module #4, 0.5 Gbps

As a result, as illustrated in FIG. 10, the input-output modules #1 to #4 (101) output only the permitted amounts of data indicated by the priority-level-basis output permission bandwidth information FB2 included in the pieces of feedback information FB.

In the input-output module #1 (101), 5.5 Gbps data of the input 8-Gbps high-priority data is transferred under the above-described bandwidth allocation control, and 2.5 Gbps data is discarded as discard packets Px. In the input-output module #2 (101), 1.5 Gbps data of the input 4-Gbps high-priority data is transferred, and 2.5 Gbps data is discarded as discard packets Px. In the input-output module #3 (101), 2.5 Gbps data of the input 5-Gbps high-priority data is transferred, and 2.5 Gbps data is discarded as discard packets Px. In the input-output module #4 (101), 0.5 Gbps data of the input 3-Gbps high-priority data is transferred, and 2.5 Gbps data is discarded as discard packets Px. In this manner, the amounts of packets P to be discarded become equal for the input-output modules #1 to #4 (101).

In the above-described bandwidth allocation example, an example in which the amount of packets to be discarded is caused to be equal for the input-output modules has been described. However, the outflow rate may be reduced in accordance with an input bandwidth ratio, and may be changed by changing the content of processing. In the above-described example, the example in which the output bandwidth is limited to 10 Gbps has been described; however, the output bandwidth is not limited to this and may be changed freely.

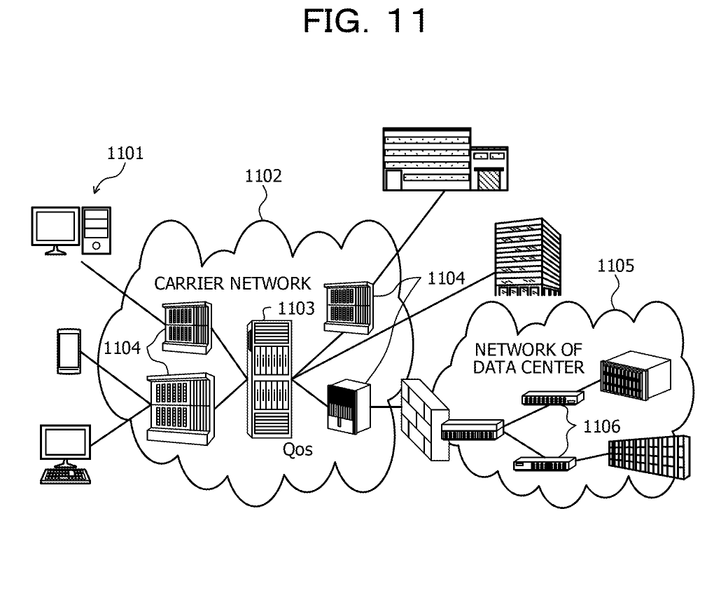

FIG. 11 is a diagram illustrating an example of the configuration of a network that is an example to which the transmission apparatus according to the embodiment is applied. In a configuration in which a terminal 1101 of a user or the like accesses a server 1103 on a carrier network 1102, the above-described transmission apparatus 100 is applicable to a relay apparatus 1104 in the carrier network 1102. In a configuration in which a network 1105 of a data center is connected to the server 1103 on the carrier network 1102, the above-described transmission apparatus 100 is applicable to a relay apparatus 1106 in the network 1105.

As a result, when data transfer is relayed in the carrier network 1102 and in the network 1105, data transfer may be performed through allocation of the bandwidth on the input port side in accordance with data priority levels and the congestion state of an output port. Even when the data from a plurality of input ports (a plurality of input-output modules) is concentrated at one output port (one input-output module), data transfer may be performed smoothly, and the relay function may be improved.

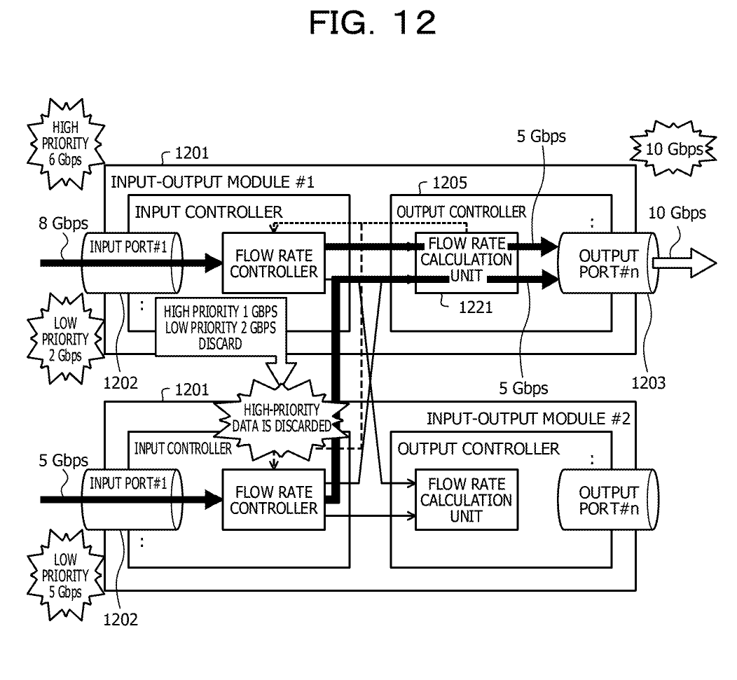

FIG. 12 is a diagram illustrating bandwidth allocation in an existing transmission apparatus. The bandwidth of an output port 1203 is limited to 10 Gbps. In a configuration in which data flows out from input ports #1 (1202) of two input-output modules #1 and #2 (1201), when the sum of bandwidths of input data is smaller than or equal to 10 Gbps, the entire input data may be output from the output port 1203.

Here, as illustrated in FIG. 12, 8-Gbps data (6-Gbps high-priority data and 2-Gbps low-priority data) is input to the input-output module #1 (1201). To the input-output module #2 (1201), 5-Gbps data (5-Gbps low-priority data) is input.

A flow rate calculation unit 1221 of an output-side controller 1205 measures the amount of input data. However, hitherto the measured value is only fed back (corresponding to back pressure) to the input-output modules #1 and #2 (1201). Here, with the existing configuration, the input-output module #1 and the input-output module #2 (1201) do not grasp the congestion state of another input-output module. Thus, in the input-output modules #1 and #2 (1201), control is simply performed such that the bandwidth is limited to 5 Gbps, which is obtained by evenly dividing the bandwidth, 10 Gbps, of the output port 1203 into two.

Thus, since the bandwidth of the input-output module #1 (1201) is limited to 5 Gbps, 1 Gbps data of the high-priority data is discarded. Furthermore, 2 Gbps data of the low-priority data is also discarded.

In this manner, appropriate handling may not be performed with the existing technology in the case where the amount of data differs on an input-output module basis for the plurality of input-output modules in the transmission apparatus or the case where packets with different priority levels are input in an unbalanced manner (concentrated at a specific port). As a result, communication quality is degraded by packet transmission delay occurring at a specific input-output module and unbalanced discarding (discarding of high-priority packets).

In contrast to this, in the embodiment, in the case where a plurality of input-output modules are provided in a transmission apparatus, control is performed such that the bandwidth is allocated to input ports of the plurality of input-output modules in accordance with data priority levels and the congestion state of an output port. By performing the bandwidth allocation control every unit processing time, bandwidth allocation may be appropriately performed in accordance with the amount of data of packets input as the time elapses or a change in priority levels.

In the embodiment, the input controller transmits the priority levels and queue lengths of packets to the output-side controller side, and the output-side controller side calculates a bandwidth on a priority-level basis, based on the priority levels and queue lengths of the packets, and transmits the bandwidths to a plurality of input controllers (input-output modules). As a result, bandwidth allocation may be appropriately performed on the plurality-of-input-controllers (input-output-modules) side in accordance with the amount of data to be input or priority levels.

Even when the data from the plurality of input-output modules is concentrated at an output port of one input-output module, bandwidth control may be performed on the plurality of input-output modules in accordance with the priority levels and the congestion state of the output port. For example, high-priority packets may be output in a prioritized manner, and delay or discarding of high-priority packets may be limited, and thus the communication quality of high-priority packets may be improved. Furthermore, low-priority packets may be discarded in a prioritized manner. As a result, the transmission apparatus may smoothly perform data transfer to destinations in accordance with priority levels even at the time of congestion, and the transfer (relay) function may be improved.

The embodiments are described using the example in which packets are input from one input port per input-output module, and output from one output port of an input-output module in the transmission apparatus. As illustrated in FIG. 1 and the like, bandwidth control may also be similarly applied to a configuration in which each input-output module has a plurality of input ports and output ports, and performed. Using, as a reference, an output port that outputs a plurality of packets collectively, bandwidth control is performed on the input ports of the plurality of input-output modules that transfer packets to this output port. In addition, even when the number of input-output modules that the transmission apparatus has is one, the configuration having a plurality of input ports and output ports may be applied to this one input-output module, and the bandwidth regarding packet transfer performed between the plurality of input ports and output ports may be controlled.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission method executed by a transmission apparatus including a plurality of reception modules that receive packets and transfer the packets to transfer destinations corresponding to destinations of the packets, and a plurality of transmission modules that receive packets from any of the plurality of reception modules and transmit the packets to destinations of the packets, the transmission method comprising:
extracting, by each of the plurality of reception modules, the amounts of data for respective priority levels of the received packets;
transmitting, to one of the plurality of transmission modules, information regarding the extracted amounts of data for the respective priority levels;
determining, by the one of the plurality of transmission modules, the amounts of discard data to be discarded for the plurality of respective reception modules, based on the extracted amounts of data for the respective priority levels and the amount of packet data that is able to be output; and
notifying the plurality of reception modules of feedback information related to the determined amounts of discard data.

2. The transmission method according to claim 1, further comprising:
calculating, for each of the plurality of reception modules, output permission bandwidths for the respective priority levels using the determined amounts of discard data, each of the output permission bandwidths indicating a limit value for the amount of data to be output to the one of the plurality of transmission modules,
wherein the notifying includes notifying in which the plurality of reception modules are notified of, as the feedback information, the output permission bandwidths calculated for the respective priority levels for each of the plurality of reception modules.

3. The transmission method according to claim 1,
wherein the determining includes determining in which the amounts of discard data are determined for the plurality of respective reception modules such that the amounts of discard data for the plurality of respective reception modules become equal.

4. The transmission method according to claim 3,
wherein the determining in which the amounts of discard data are determined such that the amounts of discard data for the plurality of respective reception modules become equal includes:
calculating a first difference by subtracting the sum of bandwidths for high-priority packets that are to be input to input ports of the plurality of reception modules and have the highest priority level, from a bandwidth of an output port of the one of the plurality of transmission modules,
calculating a second difference by subtracting the first difference from the sum of bandwidths for low-priority packets that are to be input to the input ports of the plurality of reception modules and have a lower priority level than the high-priority packets, and
calculating the amounts of discard data by dividing the second difference by the total number of the input ports of the plurality of reception modules to which the low-priority packets are to be input.

5. The transmission method according to claim 1,
wherein the determining includes determining in which the amounts of discard data for the plurality of respective reception modules are determined, based on the amount of data of high-priority packets having the highest priority level among the extracted, such that the high-priority packets are not to be discarded amounts of data for the respective priority levels.

6. The transmission method according to claim 1,
wherein the determining includes determining in which the amounts of discard data for the plurality of respective reception modules are determined such that discard-data allocation is performed based on an input bandwidth ratio of the plurality of respective reception modules.

7. The transmission method according to claim 1, wherein
the transmitting includes notifying in which the one of the plurality of transmission modules is notified, by each of the plurality of reception modules, of a data length per unit processing time of a queue storing the packets, and
the determining includes determining in which the amounts of discard data for the plurality of respective reception modules are determined by the one of the plurality of transmission modules, based on a data length per unit processing time of the packets output from an output port of the one of the plurality of transmission modules and the data length per unit processing time of the queue.

8. The transmission method according to claim 7, wherein
the queue includes a high-priority queue in which high-priority packets having the highest priority level are stored, and a low-priority queue in which low-priority packets having a lower priority level than the high-priority packets are stored, and
the transmitting includes notifying in which the one of the plurality of transmission modules is notified of a data length per unit processing time of the high-priority queue and a data length per unit processing time of the low-priority queue.

9. A transmission apparatus comprising:
a plurality of reception modules that receive packets and transfer the packets to transfer destinations corresponding to destinations of the packets; and
a plurality of transmission modules that receive packets from any of the plurality of reception modules and transmit the packets to destinations of the packets,
wherein each of the plurality of reception modules is configured to:
extract the amounts of data for respective priority levels of the received packets, and
transmit, to one of the plurality of transmission modules, information regarding the extracted amounts of data for the respective priority levels, and
wherein the one of the plurality of transmission modules is configured to:
determine the amounts of discard data to be discarded for the plurality of respective reception modules, based on the extracted amounts of data for the respective priority levels and the amount of packet data that is able to be output, and
notify the plurality of reception modules of feedback information related to the determined amounts of discard data.

10. A non-transitory computer-readable storage medium storing a program that causes a transmission apparatus to execute a process, the transmission apparatus including a plurality of reception modules that receive packets and transfer the packets to transfer destinations corresponding to destinations of the packets, and a plurality of transmission modules that receive packets from any of the plurality of reception modules and transmit the packets to destinations of the packets, the process comprising:
receiving, by one of the plurality of transmission modules, the amounts of data for respective priority levels of the packets from each of the plurality of reception modules;
determining the amounts of discard data to be discarded for the plurality of respective reception modules, based on the extracted amounts of data for the respective priority levels and the amount of packet data that is able to be output; and
notifying the plurality of reception modules of feedback information related to the determined amounts of discard data.
